(19) United States
(12) Patent Application Publication
(10) Pub. No.: US 2025/0298150 A1
(43) Pub. Date: Sep. 25, 2025

(54) CONSTANT ENVELOPE MULTIPLEXING APPARATUS AND METHOD FOR THREE SAME POWER SIGNALS

(71) Applicant: ELECTRONICS AND TELECOMMUNICATIONS RESEARCH INSTITUTE, Daejeon (KR)

(72) Inventor: Hyoung Soo LIM, Daejeon (KR)

(73) Assignee: ELECTRONICS AND TELECOMMUNICATIONS RESEARCH INSTITUTE, Daejeon (KR)

(21) Appl. No.: 18/862,783

(22) PCT Filed: Sep. 15, 2022
(86) PCT No.: PCT/KR2022/013818

§ 371 Date: Nov. 4, 2024

(30) Foreign Application Priority Data
Jun. 13, 2022 (KR) 10-2022-0071672

(51) Int. Cl. G01S 19/35; G01S 19/25; G01S 19/30

(52) U.S. Cl. CPC G01S 19/35; G01S 19/25; G01S 19/30

(57) ABSTRACT

A satellite navigation signal generation apparatus may comprise: a signal generator generating a first satellite navigation signal, a second satellite navigation signal, and a third satellite navigation signal; a modulator modulating signals with same phases, which are generated by configuring an amplitude and a phase of an in-phase component and an amplitude and a phase of a quadrature-phase component based on a relationship of absolute sample values corresponding respectively to variable instantaneous powers of the first to third satellite navigation signals, into different chip pulse waveforms; and a multiplexer performing constant envelope multiplexing on the satellite navigation signals modulated by the modulator, wherein the modulator performs chip pulse modulation in which the absolute sample value of the first satellite navigation signal and the absolute sample value of the second satellite navigation signal have a first value A and a second value B with a frequency of 0.5, respectively.

### TECHNICAL FIELD

The present invention relates to a satellite navigation signal generation and transmission system, and more particularly, to an apparatus and method for constant envelope multiplexing of three equal power signals for a satellite navigation signal generation and transmission system.

### RELATED ART

Unlike general wireless transmission systems, a satellite navigation system transmits a plurality of signals simultaneously on the same frequency in the state where all transmit signals are spectrum-spread with different spreading codes and signals having the same phase of in-phase (I) or quadrature-phase (Q) are modulated with different chip pulses.

In order to reduce the complexity of generating and receiving satellite navigation signals, every chip pulse has one or two absolute values, and in special cases such as Galileo E5, up-conversion or down-conversion is performed by a certain frequency offset.

Here, given that there are many restrictions on available power and system weight and volume due to the nature of the operating environment of the satellite navigation payload including the satellite navigation signal generation and transmission system, the satellite navigation signals are designed to have a constant envelope so as to maximize the efficiency of the high-power amplifier for transmitting the satellite navigation signal to the user receiver on the ground. That is, the sample value of the multiplexer output signal for a plurality of signals using the same frequency has a constant magnitude.

However, when the number of signals to be multiplexed is three or more, it is impossible to achieve a constant envelope through a simple linear combination and thus an intermodulation component is added between the signals to be multiplexed to arbitrarily transform the signals to have a constant envelope.

Such an intermodulation component can be regarded as random noise in terms of receiving the satellite navigation signal, and the power of the intermodulation component among the total transmission power of the satellite navigation payload can be regarded as an inevitable power efficiency loss of the multiplexer for the maximum efficiency of the high-power amplifier.

Therefore, there is a need of an additional design of a constant envelop multiplexing method that is capable of maximizing power efficiency within the range satisfying the design requirements in the case that there is a change in the number of signals of the existing satellite navigation system or a new satellite navigation system is designed.

### DISCLOSURE

### Technical Problem

The present invention has been derived to meet the needs of the technical field related to the satellite navigation signal generation and transmission system, and it is an object of the present invention to provide an apparatus and method for constant envelope multiplexing of three equal-power signals.

It is another object of the present invention to provide an apparatus and method for constant envelope multiplexing of three equal-power signals that is capable of defining and using pulse waveform characteristics for a constant envelop multiplexing scheme.

### Technical Solution

A constant envelope multiplexing apparatus for three equal-power signals, according to a first exemplary embodiment of the present disclosure for achieving the above-described objective, may comprise: a signal generator generating a first satellite navigation signal, a second satellite navigation signal, and a third satellite navigation signal; a modulator modulating signals with same phases, which are generated by configuring an amplitude and a phase of an in-phase component and an amplitude and a phase of a quadrature-phase component based on a relationship of absolute sample values corresponding respectively to variable instantaneous powers of the first to third satellite navigation signals, into different chip pulse waveforms; and a multiplexer performing constant envelope multiplexing on the satellite navigation signals modulated by the modulator, wherein the modulator performs chip pulse modulation in which the absolute sample value of the first satellite navigation signal and the absolute sample value of the second satellite navigation signal have a first value A and a second value B with a frequency of 0.5, respectively.

A constant envelope multiplexing apparatus for three equal-power signals, according to a second exemplary embodiment of the present disclosure for achieving the above-described objective, may comprise, as a satellite navigation signal generation method executed by an apparatus generating satellite navigation signals in a satellite navigation system, generating a first satellite navigation signal, a second satellite navigation signal, and a third satellite navigation signal; modulating signals with same phases, which are generated by configuring an amplitude and a phase of an in-phase component and an amplitude and a phase of a quadrature-phase component based on a relationship of absolute sample values corresponding respectively to variable instantaneous powers of the first to third satellite navigation signals, into different chip pulse waveforms; and performing constant envelope multiplexing on the satellite navigation signals modulated by the modulator, wherein, when being modulated into chip pulse waveforms, the absolute sample value of the first satellite navigation signal and the absolute sample value of the second satellite navigation signal have a first value A and a second value B with a frequency of 0.5, respectively.

The absolute sample value of the second satellite navigation signal may have the second value B during a period in which the absolute sample value of the first satellite navigation signal is the first value A.

The absolute sample values of the first and second satellite navigation signals may equal in average and the average power of each signal may equal to half the sum of squares of the first value A and the second value B.

At any sample time, a sum of the absolute sample value of the first satellite navigation signal and the absolute sample value of the second satellite navigation signal may be equal to a sum of the first and second values A and B.

The absolute sample value of the third satellite navigation signal may be a constant value C.

A sum of a square of the first value A and a square of the second value B may be equal to twice a square of the constant value C.

The absolute sample values of the first to third satellite navigation signals may have a ratio of A:B:C and B:A:C with a frequency of 0.5 in the constant envelope multiplexing upon an arbitrary multiplexing power efficiency for the constant envelope multiplexing being determined. The multiplexer may generate a constant envelope multiplexing output signal S_{MUX} at an arbitrary time t by Equation 2:

$${S}_{MUX} ( t ) = {s}_{1} ( t ) + {s}_{2} ( t ) + j [ {s}_{3} ( t ) - {Ds}_{1} ( t ) {s}_{2} ( t ) {s}_{3} ( t ) ] \qquad [ Equation 2 ]$$

A, B, C, and D may be determined, in response to the arbitrary multiplexing power efficiency η is given, by Equations 3 to 6:

$$A = \sqrt{\frac{η - \sqrt{( 4 η - 3 ) η}}{3}} \qquad [ Equation 3 ]$$

$$B = \sqrt{\frac{η + \sqrt{( 4 η - 3 ) η}}{3}} \qquad [ Equation 4 ]$$

$$C = \sqrt{\frac{η}{3}} \qquad [ Equation 5 ]$$

$$D = \frac{3}{η} \qquad [ Equation 6 ]$$

where, η is greater than 0 and equal to or less than 1.

The absolute sample value of the first satellite navigation signal and the absolute sample value of the second satellite navigation signal may have the first value A and the second value B crisscross with a probability of 0.5, and the absolute sample value of the third satellite navigation signal may be a constant value C.

The signal generator may generate signals spectrum-spread with different spreading codes to the first to third satellite navigation signals.

### Advantageous Effects

According to the present invention, it is possible to effectively perform constant envelope multiplexing of three satellite navigation signals having the equal power, thereby maximizing the power efficiency of the system within a range satisfying the design requirements of the satellite navigation system.

In addition, according to the present invention, it is possible to effectively perform constant envelope multiplexing required for satellite navigation signals according to an arbitrary multiplexing power efficiency of the satellite navigation system. That is, it is possible to provide a constant envelope multiplexing scheme capable of effectively achieving an arbitrary multiplexing power efficiency target in a satellite navigation system that simultaneously transmits three signals with the same power on the same frequency.

That is, by satisfying the condition of the present invention that one of the three signals to be multiplexed has an absolute sample value of a constant value and the remaining two signals have an absolute sample value of one of two values crisscross with a probability of 1/2, it is possible to achieve the effect that each sign pattern of all satellite navigation signals can be freely designed in consideration of the spectrum and interference characteristics of each signal independently of the constant envelope multiplexing method.

### DESCRIPTION OF DRAWINGS

The accompanying drawings, which are included as a part of the detailed description for better understanding of the present invention, provide embodiments of the present invention, and together with the detailed description, illustrate the technical spirit of the present invention.

FIG. 1 is a schematic diagram illustrating a satellite navigation system to which an apparatus for constant envelope multiplexing of three identical power signals according to an embodiment of the present invention can be applied.

FIG. 2 is a schematic block diagram illustrating a basic configuration of an apparatus for constant envelope multiplexing of N equal power signals that can be employed in the satellite navigation system of FIG. 1.

FIG. 3 is an exemplary constellation diagram of an output signal of the constant envelope multiplexing apparatus of FIG. 2 by constant envelope multiplexing three equal power signals.

FIG. 4 is a diagram illustrating a detailed configuration of a part of the constant envelope multiplexing device of FIG. 2.

FIG. 5 is a block diagram illustrating an additional configuration that can be employed in a satellite navigation payload of the satellite navigation system of FIG. 1.

### BEST MODE OF THE INVENTION

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, ‘at least one of A and B’ may mean ‘at least one of A or B’ or ‘at least one of combinations of one or more of A and B’. Also, in exemplary embodiments of the present disclosure, ‘one or more of A and B’ may mean ‘one or more of A or B’ or ‘one or more of combinations of one or more of A and B’.

In exemplary embodiments of the present disclosure, ‘(re)transmission’ may mean ‘transmission’, ‘retransmission’, or ‘transmission and retransmission’, ‘(re)configuration’ may mean ‘configuration’, ‘reconfiguration’, or ‘configuration and reconfiguration’, ‘(re)connection’ may mean ‘connection’, ‘reconnection’, or ‘connection and reconnection’, and ‘(re-)access’ may mean ‘access’, ‘re-access’, or ‘access and re-access’.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

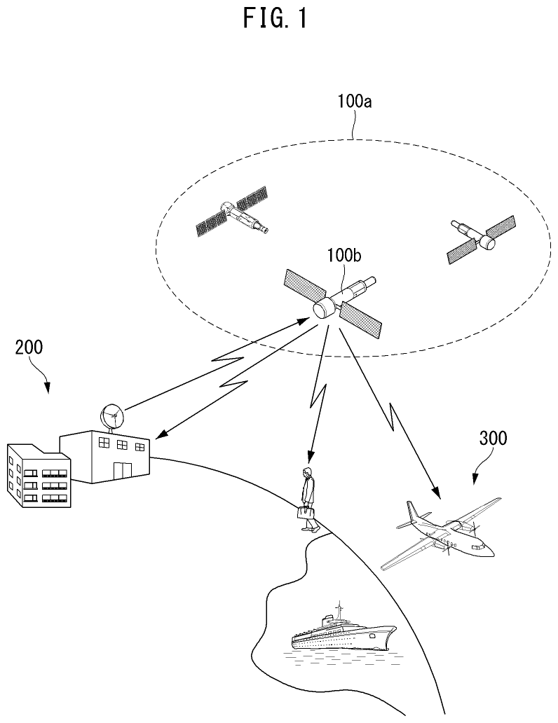

FIG. 1 is a schematic diagram illustrating a satellite navigation system to which an apparatus for constant envelope multiplexing of three identical power signals according to an embodiment of the present invention can be applied.

Referring to FIG. 1, the satellite navigation system is a system that provides 3D position and time synchronization information through distance measurement using satellite position information and radio waves received from a satellite group consisting of a plurality of satellites on the Earth's orbit. The satellite navigation system may be referred to as a global navigation satellite system (GNSS).

The navigation satellite of the satellite navigation system can transmit several satellite navigation signals on the same carrier in order to provide positioning, navigation, and timing services for various purposes to users. A navigation satellite may be referred to as a satellite navigation payload.

The satellite navigation system may be divided into a space segment 100a, a control segment 200, and a user segment 300. The space segment 100a includes a satellite navigation payload 100b, the control segment 200 includes a signal monitoring station and a master control station, and the user unit 300 includes user equipment such as personal satellite equipment, aircraft, and ships. The master control station of the control segment 200 may be connected to the satellite navigation payload 100b through a data uplink channel via a ground antenna and may interoperate with the signal monitoring station.

The satellite navigation system may transmit satellite navigation signals using frequency bands such as L1, L2, L5, L6, LEX, E1, E2, E5a, E5b, E6, B1, B1-2, B2, B3, and S bands. The satellite navigation system may include global positioning system (GPS), global navigation satellite system (GLONASS/GNSS), Galileo, BeiDou navigation system (BDS), Quasi-Zenith satellite system (QZSS), navigation with Indian constellation (NavIC), and Korean positioning system (KPS).

In this embodiment, it is prevented that a carrier wave spectrum is distorted due to the PA non-linearity caused by the inconstancy of the magnitude of the multiplexed signal power every moment at the input terminal of a PA mounted on the satellite navigation payload 100b, and the constant envelope (CE) characteristics of the multiplexed signal of the satellite navigation payload is effectively guaranteed.

To this end, the modulator is set in configuration or controlled in operation to satisfy the condition that one of the three signals to be multiplexed has an absolute sample value of a constant value and the remaining two signals have an absolute sample value of one of two values crisscross with a probability of 1/2.

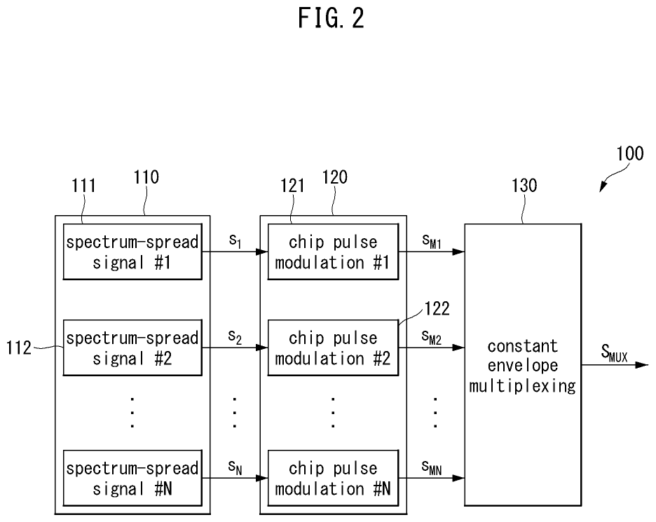

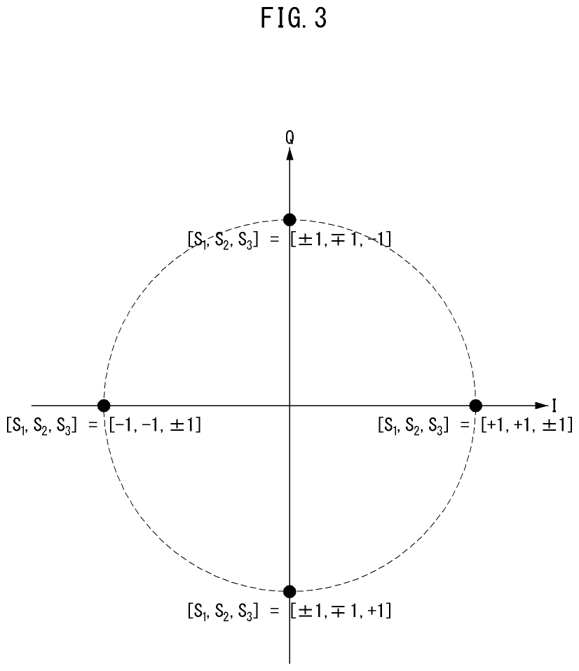

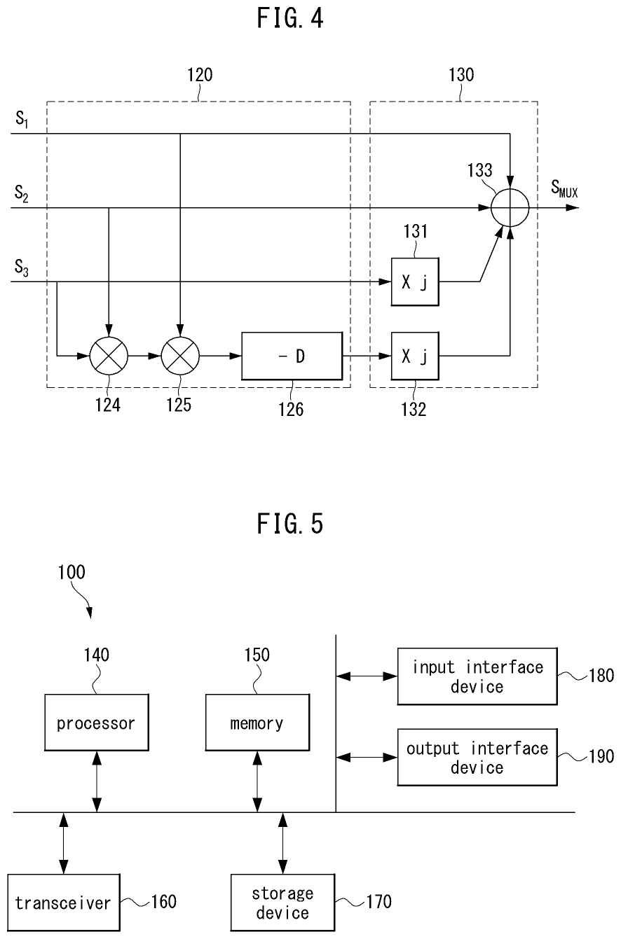

FIG. 2 is a schematic block diagram illustrating a basic configuration of an apparatus for constant envelope multiplexing of N equal power signals (N is an arbitrary natural number equal to or greater than 3) that can be employed in the satellite navigation system of FIG. 1. FIG. 3 is an example of a constellation diagram of a constant envelope multiplexed output signal of three identical power signals that can be obtained from a satellite navigation signal generating apparatus of a comparative example. FIG. 4 is a diagram illustrating a detailed configuration of a part of the constant envelope multiplexing device of FIG. 2.

Referring to FIG. 2, the constant envelope multiplexing apparatus 100 may be mounted on a satellite navigation payload and may include a signal generator 110, a modulator 120, and a multiplexer 130.

The signal generator 110 generates a first satellite navigation signal S₁, a second satellite navigation signal S₂, and an N^{th} satellite navigation signal S_{N}. N may be one of natural numbers equal to or greater than 3. The signal generator 110 may generate signals spread with different spreading codes as first to third satellite navigation signals. The signal generator 110 may use a direct sequence (DS) method, a frequency hopping (FH) method, a time hopping (TH) method, a chirp method, or a hybrid method obtained by altering and combining basic systems of two or more thereof.

The modulator 120 modulates, among the signals input from the signal generator 110, the signals with the same phase acquired according to the amplitude and phase of in-phase component and the amplitude and phase of the quadrature-phase component into different chip pulse waveforms. The modulated signals S_{M1}, S_{M2}, . . . , S_{MN} are sent to the multiplexer 130. The modulator 120 may set the amplitude and phase of the in-phase component and the amplitude and phase of the quadrature-phase component based on the relationship between absolute sample values corresponding to the respective variable instantaneous powers of the first to third satellite navigation signals.

For example, the power of a signal may be divided into an average power and an instantaneous power. Signals having the same constant value of instantaneous power have the same size of one chip pulse sample and are modulated into different chip pulses according to the code pattern of each sample.

Meanwhile, in the case where the signals to be multiplexed are three in number and equal in power, the achievable power efficiency of constant envelope multiplexing that can be implemented by linear combination of signals and their intermodulation does not exceed 75%. The constant envelope multiplexing with a power efficiency of 75% has the same form as Equation 1 and the same constellation as quadrature phase shift keying (QPSK) as shown in FIG. 3.

$${s}_{MUX} ( t ) = \frac{1}{2} \{ {s}_{1} ( t ) + {s}_{2} ( t ) - j [ {s}_{3} ( t ) - {s}_{1} ( t ) {s}_{2} ( t ) {s}_{3} ( t ) ] \} \qquad [ Equation 1 ]$$

In Equation 1, s_{MUX}(t) is a constant envelope multiplexed output signal, and s₁(t), s₂(t), s₃(t) are three equal instantaneous power signals to be multiplexed.

As in the comparative example expressed by Equation 1 above, the problem of low power efficiency of less than 75% may be improved when signals are not equal in power. That is, the present embodiment solves the problem of low power efficiency by designing the signals to have different instantaneous powers under the condition of having the equal average power in the case where the same design condition is given for the powers of all the signals to be multiplexed.

As such, in this embodiment, a constant envelope multiplexing method for three signals having one or two instantaneous power values and having the equal average power and a chip pulse form for this are provided as follows.

Of the total three multiplexing target signals s₁(t), s₂(t), s₃(t), two signals s₁(t), s₂(t) are variable instantaneous power signals to be controlled to each have an absolute sample value A and B with a frequency of 0.5.

That is, the average of the absolute values of s₁(t) and s₂(t) holds the relationship of

$$\overline{\vert {s}_{1} ( t ) \vert} = \overline{\vert {s}_{2} ( t ) \vert} = \frac{A + B}{2} .$$

Also, the absolute values of s₁(t) and s₂(t) hold the relationship of |S₁(t)|=|S₂(t)|=A+B.

That is, during the period in which the absolute sample value of one signal is A, the absolute sample value of the other signal must have a value of B. The remaining one signal s₃(t) has an absolute sample value of a constant value C.

Here, assuming that the absolute sample value A is smaller than the absolute sample value B (A<B), the average powers of the three signals are equal, resulting in establishment of A²+B²=2C²(0<A<C<B).

For three signals satisfying these conditions, the constant envelope multiplexing method provided in this embodiment is shown in Equation (2).

$${S}_{MUX} ( t ) = {s}_{1} ( t ) + {s}_{2} ( t ) + j [ {s}_{3} ( t ) - {Ds}_{1} ( t ) {s}_{2} ( t ) {s}_{3} ( t ) ] \qquad [ Equation 2 ]$$

Here, for the multiplexing power efficiency η(0<η≤1) to be achieved, A, B, C and D are given as in Equations 3 to 6 below.

That is, when an arbitrary multiplexing power efficiency is given in the satellite navigation payload, A, B, C, and D can be determined by Equations 3 to 6 below.

$$A = \sqrt{\frac{η - \sqrt{( 4 η - 3 ) η}}{3}} \qquad [ Equation 3 ]$$

$$B = \sqrt{\frac{η + \sqrt{( 4 η - 3 ) η}}{3}} \qquad [ Equation 4 ]$$

$$C = \sqrt{\frac{η}{3}} \qquad [ Equation 5 ]$$

$$D = \frac{3}{η} \qquad [ Equation 6 ]$$

In the equations, η is greater than 0 and equal to or less than 1.

In this way, given any multiplexing power efficiency η(0<η≤1) to be achieved, the constant envelope multiplexing method for the three signals s₁(t), s₂(t), s₃(t), satisfying |s₁(t)|:|s₂(t)|:|s₃(t)|=A:B:C and |s₁(t)|:|s₂(t)|:|s₃(t)|=B:A:C with a ratio of the absolute sample values of 0.5 can be easily determined by Equations 2 to 6 above.

With reference back to FIG. 2, the multiplexer 130 performs constant envelope multiplexing on the modulated signals input from the modulator 120. The multiplexer 130 may be configured to expand some of the modulated signals input from the modulator 120 to the complex plane. The constant envelope multiplexed output signal (S_{MUX}) generated by the multiplexer 130 may be connected to an antenna after going through various analog circuits such as up-convertors, digital-analog convertors, filters and high-power amplifiers, and may be transmitted, as a multiplexed satellite navigation signal, to a user receiver of the user segment, the signal monitoring station of the control segment, the master control station, and the like.

Table 1 below shows an example of calculating the multiplexing parameters for achieving various multiplexing power efficiencies with Equations 3 to 6

TABLE 1

| power efficiency (%) | A | B | C | D |
|---|---|---|---|---|
| 93 | 0.192967 | 0.763390 | 0.556776 | 3.225806 |
| 94 | 0.177743 | 0.771410 | 0.559762 | 3.191489 |
| 95 | 0.161473 | 0.779269 | 0.562731 | 3.157895 |
| 96 | 0.143762 | 0.786977 | 0.565685 | 3.125000 |
| 97 | 0.123956 | 0.794545 | 0.568624 | 3.092784 |
| 98 | 0.100787 | 0.801982 | 0.571548 | 3.061224 |
| 99 | 0.070982 | 0.809297 | 0.574456 | 3.030303 |

The above-described constant envelope multiplexing output signal S_{MUX} may be generated using the constant envelope multiplexing device structure shown in FIG. 4.

In more detail, the constant envelope multiplexing apparatus 100 includes a modulator 120 and a multiplexer 130 mounted on a satellite navigation payload, the modulator 120 may include a first combining unit 124, a second combining unit 125, and a chip pulse modulator 126 to generate the constant envelope multiplexing output signal represented by Equation 2, and the multiplexer 130 may include a first extension unit 131, a second extension unit 132, and an addition unit 133.

Of the three signals s₁, s₂, s₃ inputted to the modulator 120, two signals s₁ and s₂ are configured such that their absolute sample values |s₁| and |s₂| have one of two values A and B crisscross with a probability of 1/2. Here, the crisscross form may include a form that crisscrosses each other in an arbitrary order such as ABBABAA and BAABABB pair and AABBAAAB and BBAABBBA pair in addition to a form that crisscrosses once such as ABABAB and BABABA pair. That is, the absolute sample value |s₁| of the first satellite navigation signal s₁ may be configured to have the value of A expressed by Equation 3 or the value of B expressed by Equation 4 with a probability of 1/2, and the absolute sample value |s₂| of the satellite navigation signal s₂ may be configured to have the value of B expressed by Equation 4 or the value of A expressed by Equation 3 with a probability of 1/2.

In other words, the first satellite navigation signal s₁ may be modulated using the first chip pulse waveform having an absolute value as in Equation 3 or Equation 4 according to a predetermined multiplexing power efficiency. In addition, the second satellite navigation signal s₂ may be modulated using a second chip pulse waveform having an absolute value as in Equation 4 or Equation 3 according to a predetermined multiplexing power efficiency.

And the remaining signal s₃ of the three signals s₁, s₂, s₃ input to the modulator 120 is configured to have the absolute sample value |s₃| of one constant value C. The absolute value |s₃| of the third satellite navigation signal may be modulated using the third chip pulse waveform based on Equation 5 to be proportional to the square root of the predetermined multiplexing power efficiency.

The chip pulse modulation unit 126 may receive the three signals s₁, s₂, s₃ inputted to the modulator 120 through the first and second combining units 124 and 125 and modulate the received signals into the product s₁(t) s₂(t)s₃(t) of the first to third satellite navigation signals using the fourth chip pulse waveform based on Equation 6 to have a characteristic inversely proportional (1/x) to the square root of the predetermined multiplexing power efficiency. The product of the first to third satellite navigation signals may be referred to as a fourth satellite navigation signal.

The first expansion unit 131 may expand the modulated third satellite navigation signal to a complex plane. In addition, the second expansion unit 132 may expand the modulated signal from the chip pulse modulator 126 to the complex plane.

The addition unit 133 generates a constant envelope multiplexed output signal (S_{MUX}) by integrating real-part signals of the first and second satellite navigation signals and imaginary-part signals obtained by expanding the signal modulated from the third satellite navigation signal and the product of the first to third satellite navigation signals.

Meanwhile, the above-described first and second expansion units 131 and 132 are not provided in some input terminals of the multiplexer 130 but are provided in some output terminals of the modulator 120 or provided as a separate functional unit or component.

FIG. 5 is a block diagram illustrating an additional configuration that can be employed in a satellite navigation payload of the satellite navigation system of FIG. 1.

Referring to FIG. 5, the satellite navigation payload 100 on which the constant envelope multiplexing apparatus is mounted may include at least one processor 140, a memory 150, and a transceiver 160 connected to a satellite network to perform communication. The constant envelope multiplexing apparatus may be provided as a part of the transceiver 160.

In addition, the satellite navigation device 100 may selectively further include a storage device 170, an input interface device 180, and an output interface device 190, if necessary. The components included in the satellite navigation payload 100 may be connected via a bus to communicate with each other or may be connected via an individual interface or an individual bus centering on the processor 120. For example, the processor 140 may be connected to at least one of the memory 150, the transceiver 160, the storage device 170, the input interface device 180, and the output interface device 190 via a dedicated interface.

The processor 140 may execute program instructions stored in at least one of the memory 150 and the storage unit 170. The processor 140 may include a function unit for constant envelope multiplexing or at least a part of a component performing a function corresponding to the function unit. The processor 140 may refer to a central processing unit (CPU), a graphics processing unit (GPU), or a dedicated processor on which methods according to embodiments of the present invention are performed.

Each of the memory 150 and the storage unit 170 may be configured as at least one of a volatile storage medium and a non-volatile storage medium. For example, the memory 150 may be configured as at least one of a read only memory (ROM) and a random access memory (RAM).

When the processor 140 executes a program instruction stored in the memory 150, the processor 140 may be configured to perform steps for generating the above-described constant envelope multiplexing output signal by the program instruction. These program instructions may include an instruction for generating the first satellite navigation signal, the second satellite navigation signal, and the third satellite navigation signal, an instruction for setting the amplitude and phase of the in-phase component and the amplitude and phase of the quadrature-phase component based on the relationship between absolute sample values corresponding to the variable instantaneous power of the first to third satellite navigation signals, an instruction for modulating signals having the same phase, among the in-phase and quadrature-phase component signals, into different chip pulse waveforms, an instruction for constant envelope multiplexing the modulated signals, an instruction for letting the absolute sample value of the second satellite navigation signal have the second value B and letting the absolute sample value of the first satellite navigation signal have the first value A in the process of constant envelope multiplexing, an instruction for determining or selecting an arbitrary multiplexing power efficiency for constant envelope multiplexing, and an instruction for letting the absolute sample values of the first to third satellite navigation signals be A:B:C and B:A:C with a frequency of 1/2.

Meanwhile, the operation of the method according to an embodiment of the present invention may be implemented as a computer-readable program or code on computer-readable recording media. Computer-readable recording media include all types of recording devices in which information readable by a computer system is stored. The computer-readable recording media may also be distributed in a network-connected computer system to store and execute computer-readable programs or codes in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

The present disclosure is the result of research conducted with the funding of the research operation cost support project of the Korea Electronics and Telecommunications Research Institute in 2022 (22ZH1100, research on hyper-connected stereoscopic communication technology overcoming limitations of connectivity).

1. A satellite navigation signal generation apparatus comprising:
a signal generator generating a first satellite navigation signal, a second satellite navigation signal, and a third satellite navigation signal;
a modulator modulating signals with same phases, which are generated by configuring an amplitude and a phase of an in-phase component and an amplitude and a phase of a quadrature-phase component based on a relationship of absolute sample values corresponding respectively to variable instantaneous powers of the first to third satellite navigation signals, into different chip pulse waveforms; and
a multiplexer performing constant envelope multiplexing on the satellite navigation signals modulated by the modulator,
wherein the modulator performs chip pulse modulation in which the absolute sample value of the first satellite navigation signal and the absolute sample value of the second satellite navigation signal have a first value A and a second value B with a frequency of 0.5, respectively.

2. The apparatus of claim 1, wherein the absolute sample value of the second satellite navigation signal has the second value B during a period in which the absolute sample value of the first satellite navigation signal is the first value A.

3. The apparatus of claim 1, wherein the absolute sample values of the first and second satellite navigation signals equal in average and equal to half the sum of the first and second values A and B.

4. The apparatus of claim 1, wherein a sum of the absolute sample value of the first satellite navigation signal and the absolute sample value of the second satellite navigation signal is equal to a sum of the first and second values A and B.

5. The apparatus of claim 1, wherein the absolute sample value of the third satellite navigation signal is a constant value C, and a sum of a square of the first value A and a square of the second value B is equal to twice a square of the constant value C.

6. The apparatus of claim 5, wherein the absolute sample values of the first to third satellite navigation signals have a ratio of A:B:C and B:A:C with a frequency of 0.5 in the constant envelope multiplexing upon an arbitrary multiplexing power efficiency for the constant envelope multiplexing being determined.

7. The apparatus of claim 6, wherein the multiplexer generates a constant envelope multiplexing output signal S_{MUX} at an arbitrary time t by Equation 2:
$${S}_{MUX} ( t ) = {s}_{1} ( t ) + {s}_{2} ( t ) + j [ {s}_{3} ( t ) - {Ds}_{1} ( t ) {s}_{2} ( t ) {s}_{3} ( t ) ] . \qquad [ Equation 2 ]$$

8. The apparatus of claim 7, wherein A, B, C, and D are determined, in response to the arbitrary multiplexing power efficiency η is given, by Equations 3 to 6:
$$A = \sqrt{\frac{η - \sqrt{( 4 η - 3 ) η}}{3}} \qquad [ Equation 3 ]$$
$$B = \sqrt{\frac{η + \sqrt{( 4 η - 3 ) η}}{3}} \qquad [ Equation 4 ]$$
$$C = \sqrt{\frac{η}{3}} \qquad [ Equation 5 ]$$
$$D = \frac{3}{η} \qquad [ Equation 6 ]$$
where, η is greater than 0 and equal to or less than 1.

9. The apparatus of claim 1, wherein the absolute sample value of the first satellite navigation signal and the absolute sample value of the second satellite navigation signal have the first value A and the second value B crisscross with a probability of 0.5, and the absolute sample value of the third satellite navigation signal is a constant value C.

10. The apparatus of claim 1, wherein the signal generator generates signals spectrum-spread with different spreading codes to the first to third satellite navigation signals.

11. A satellite navigation signal generation method executed by an apparatus generating satellite navigation signals in a satellite navigation system, the method comprising:
generating a first satellite navigation signal, a second satellite navigation signal, and a third satellite navigation signal;
modulating signals with same phases, which are generated by configuring an amplitude and a phase of an in-phase component and an amplitude and a phase of a quadrature-phase component based on a relationship of absolute sample values corresponding respectively to variable instantaneous powers of the first to third satellite navigation signals, into different chip pulse waveforms; and
performing constant envelope multiplexing on the satellite navigation signals modulated by the modulator,
wherein, when being modulated into chip pulse waveforms, the absolute sample value of the first satellite navigation signal and the absolute sample value of the second satellite navigation signal have a first value A and a second value B with a frequency of 0.5, respectively.

12. The method of claim 11, wherein the absolute sample value of the second satellite navigation signal has the second value B during a period in which the absolute sample value of the first satellite navigation signal is the first value A.

13. The method of claim 11, wherein the absolute sample values of the first and second satellite navigation signals equal in average and equal to half the sum of the first and second values A and B.

14. The method of claim 11, wherein a sum of the absolute sample value of the first satellite navigation signal and the absolute sample value of the second satellite navigation signal is equal to a sum of the first and second values A and B.

15. The method of claim 11, wherein the absolute sample value of the third satellite navigation signal is a constant value C, and a sum of a square of the first value A and a square of the second value B is equal to twice a square of the constant value C.

16. The method of claim 15, wherein the absolute sample values of the first to third satellite navigation signals have a ratio of A:B:C and B:A:C with a frequency of 0.5 in the constant envelope multiplexing upon an arbitrary multiplexing power efficiency for the constant envelope multiplexing being determined.

17. The method of claim 16, wherein the multiplexer generates a constant envelope multiplexing output signal S_{MUX} at an arbitrary time t by Equation 2:
$${S}_{MUX} ( t ) = {s}_{1} ( t ) + {s}_{2} ( t ) + j [ {s}_{3} ( t ) - {Ds}_{1} ( t ) {s}_{2} ( t ) {s}_{3} ( t ) ] . \qquad [ Equation 2 ]$$

18. The method of claim 17, wherein A, B, C, and D are determined, in response to the arbitrary multiplexing power efficiency η is given, by Equations 3 to 6:
$$A = \sqrt{\frac{η - \sqrt{( 4 η - 3 ) η}}{3}} \qquad [ Equation 3 ]$$
$$B = \sqrt{\frac{η + \sqrt{( 4 η - 3 ) η}}{3}} \qquad [ Equation 4 ]$$
$$C = \sqrt{\frac{η}{3}} \qquad [ Equation 5 ]$$
$$D = \frac{3}{η} \qquad [ Equation 6 ]$$
where, η is greater than 0 and equal to or less than 1.

19. The method of claim 11, wherein the absolute sample value of the first satellite navigation signal and the absolute sample value of the second satellite navigation signal have the first value A and the second value B crisscross with a probability of 0.5, and the absolute sample value of the third satellite navigation signal is a constant value C.

20. The method of claim 11, wherein the first to third satellite navigation signals are signals spectrum-spread with different spreading codes.
